(19) United States
(12) Patent Application Publication
(10) Pub. No.: US 2008/0039049 A1
(43) Pub. Date: Feb. 14, 2008

(54) Service System for Free Using of Mobile Contents

(76) Inventor: Jong-Do Park, Daegu (KR)

Correspondence Address: CANTOR COLBURN, LLP, 55 GRIFFIN ROAD SOUTH, BLOOMFIELD, CT, 06002, US

(21) Appl. No.: 10/571,811

(22) PCT Filed: Sep. 7, 2004
(86) PCT No.: PCT/KR04/02271

§ 371 Date: Jan. 4, 2007

(30) Foreign Application Priority Data
Sep. 8, 2003 (KR) 10-2003-0062808
Sep. 8, 2003 (KR) 10-2003-0062809
Nov. 4, 2003 (KR) 10-2003-0077613

(51) Int. Cl. H04M 11/00

(52) U.S. Cl. 455/406

(57) ABSTRACT

Disclosed herein is a free information usage certificate service system which is capable of distributing free information usage certificates to customers to enable the customers to use mobile contents from at least one associated mobile contents provider free of charge using the free information usage certificates. A portion of the price for online/off line product purchase or the fee for online/off line service use is returned to a customer in the form of a free information usage certificate as a reward for the product purchase or service use, thereby reducing the customer's burden of information usage fee and thus enabling the customer to benefit from a more tangible reward service.

### TECHNICAL FIELD

The present invention relates to free information usage certificate service systems, and more particularly to a free information usage certificate service system which is capable of distributing free information usage certificates to customers to enable the customers to use mobile contents from at least one associated mobile contents provider free of charge using the free information usage certificates, thereby reducing the customers' burdens of information usage fees.

### BACKGROUND ART

With the rapid advance of information communication industry, recently, mobile telephones have had rapidly improved functions compared to previous ones, thereby enabling mobile telephone subscribers to access the Internet using the mobile telephones to search for various information and use various mobile contents such as games, departing from a traditional concept of just communicating over the mobile telephones.

However, in order to use various mobile contents, the mobile telephone subscribers have to separately defray information usage fees and/or communication fees corresponding to information usage times, in addition to call fees. For this reason, customers have desires to use a mobile contents service, but cannot practically use the mobile contents service to the full due to their economic burdens.

### DISCLOSURE OF THE INVENTION

Therefore, the present invention has been made in view of the above problems, and it is an object of the present invention to provide a free information usage certificate service system wherein each affiliated store returns a portion of the price for online/offline product purchase or the fee for online/offline service use to a customer in the form of a free information usage certificate instead of various “thank-you” gifts or mileage points, as a reward for the product purchase or service use, so as to reduce the customer's burden of information usage fee to enable the customer to use mobile contents without a heavy burden, thereby providing a more tangible reward service to the user.

It is another object of the present invention to provide a free information usage certificate service system for obtaining advertising effects through various marketing techniques, such as the provision of a free information usage certificate in the form of a coupon containing an advertisement of an affiliated store that provides the free information usage certificate.

In accordance with an aspect of the present invention, the above and other objects can be accomplished by the provision of a free information usage certificate service system adapted for receiving free information use request information containing a telephone number of a customer acquiring a free information usage certificate and affiliated store identification information from an affiliated store terminal, searching sale information stored in a database for sale information corresponding to the affiliated store identification information to determine whether the corresponding sale information is present in the stored sale information, performing an authentication process based on the determination result, and transmitting the authenticated free information use request information to a communication company server so that the communication company server can deduct the amount of money corresponding to the free information usage certificate from an information usage fee to be charged to the customer's telephone number contained in the free information use request information.

In accordance with another aspect of the present invention, there is provided a free information usage certificate service system adapted for receiving free information use request information containing a telephone number of a customer acquiring a free information usage certificate and affiliated store identification information from an affiliated store terminal, searching sale information stored in a database for sale information corresponding to the affiliated store identification information to determine whether the corresponding sale information is present in the stored sale information, performing an authentication process based on the determination result, receiving information usage records included in the customer's communication fees from a communication company server, extracting, from the received records, information usage records that can be paid with the acquired free information usage certificate, and transmitting the extracted records to the communication company server so that the communication company server can deduct the amount of money that can be paid with the free information usage certificate, from an information usage fee to be charged to the customer's telephone number.

In accordance with yet another aspect of the present invention, there is provided a free information usage certificate service system adapted for receiving free information use request information containing a telephone number of a customer acquiring a free information usage certificate and affiliated store identification information from an affiliated store terminal, searching sale information stored in a database for sale information corresponding to the affiliated store identification information to determine whether the corresponding sale information is present in the stored sale information, performing an authentication process based on the determination result, receiving free information usage certificate payment request information containing the customer's telephone number from a mobile contents provider server, searching the database for free information usage certificate provision information corresponding to the customer's telephone number contained in the received free information usage certificate payment request information to determine whether the corresponding free information usage certificate provision information is present in the database, and, if the corresponding provision information is present in the database, deducting an information usage fee for contents used by the customer from a free information usable fee contained in the corresponding provision information.

In a feature of the present invention, a portion of the price for online/offline product purchase or the fee for online/offline service use is returned to a customer in the form of a free information usage certificate as a reward for the product purchase or service use, thereby reducing the customer's burden of information usage fee and thus enabling the customer to benefit from a more tangible reward service.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a free information usage certificate service system according to a first embodiment of the present invention;

FIG. 2 is a flow chart illustrating the operation of the free information usage certificate service system of FIG. 1;

FIG. 3 is a block diagram showing the configuration of a free information usage certificate service system according to a second embodiment of the present invention;

FIG. 4 is a flow chart illustrating the operation of the free information usage certificate service system of FIG. 3;

FIG. 5 is a block diagram showing the configuration of a free information usage certificate service system according to a third embodiment of the present invention; and

FIG. 6 is a flow chart illustrating the operation of the free information usage certificate service system of FIG. 5.

### BEST MODE FOR CARRYING OUT THE INVENTION

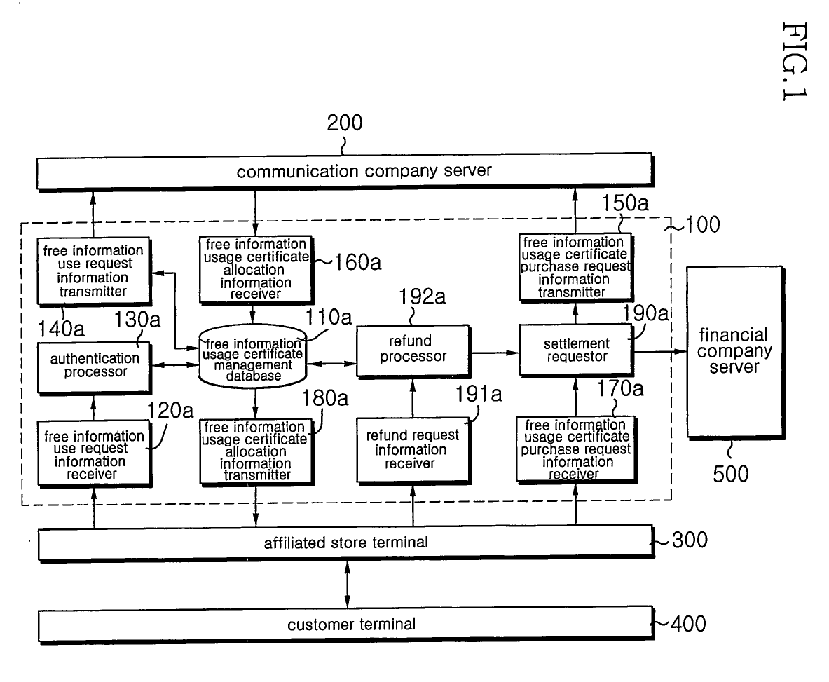

FIG. 1 is a block diagram showing the configuration of a free information usage certificate service system according to a first embodiment of the present invention.

In the present embodiment, the free information usage certificate service system is adapted to provide free information usage certificates to customers through affiliated stores. A free information usage certificate management server collects and sums up the demands for free information usage certificates from the affiliated stores, purchases the summed-up number of free information usage certificates from at least one mobile contents provider associated with at least one communication company through the communication company, and distributes the purchased free information usage certificates to the affiliated stores. Alternatively, the free information usage certificate management server may distribute the summed-up number of free information usage certificates provided from the communication company itself to the affiliated stores. The affiliated stores provide the distributed certificates to the customers. At this time, a manager of the free information usage certificate management server may online/offline issue and sell the free information usage certificates to the affiliated stores in the form of coupons.

The affiliated stores can provide the free information usage certificates to the customers as rewards for their product purchases or service use, or free of charge to entice the customers for the purpose of gaining future profits therefrom. Therefore, the free information usage certificates can be provided online/offline to the customers with or without compensation for many purposes throughout society.

The free information usage certificates can be provided in various forms such as offline coupons containing a provider's advertisement, or electronic barcodes in digital data format. That is, the free information usage certificates can be provided in various ways irrespective of form.

With reference to FIG. 1, the free information usage certificate service system according to the first embodiment of the present invention comprises a free information usage certificate management server 100, at least one communication company server 200, one or more affiliated store terminals 300, at least one customer terminal 400 and at least one financial company server 500.

The free information usage certificate management server 100 acts to sell, to affiliated stores, free information usage certificates purchased from at least one mobile contents provider associated with at least one communication company through the communication company, or free information usage certificates provided from the communication company itself, store information regarding the sales of the free information usage certificates, and perform a customer relationship management process based on the sale information.

The free information usage certificate management server 100 is adapted to sell free information usage certificates in the following three schemes.

The first scheme is a direct sale scheme wherein the free information usage certificate management server 100 is managed by the communication company, and collects and sums up the demands for free information usage certificates from the affiliated stores and directly sells the summed-up number of free information usage certificates from the mobile contents provider or the communication company itself to the affiliated stores.

The second scheme is a cooperative purchase scheme wherein the free information usage certificate management server 100 collects and sums up the demands for free information usage certificates from the affiliated stores, makes a cooperative purchase for the summed-up number of free information usage certificates from the mobile contents provider through the communication company, or from the communication company itself, and distributes the purchased free information usage certificates to the affiliated stores, and the stores provide the distributed certificates to customers.

The third scheme is a resale scheme wherein the free information usage certificate management server 100 purchases free information usage certificates from the mobile contents provider through the communication company, or from the communication company itself, in large quantities and resells the purchased free information usage certificates to the affiliated stores, and the stores provide the resold certificates to customers.

Note that the above-mentioned free information usage certificate sale schemes are just matters of sale procedure and have no effect on the configuration of the free information usage certificate service system according to the present embodiment.

In detail, the free information usage certificate management server 100 includes a free information usage certificate management database 110a, a free information use request information receiver 120a, an authentication processor 130a, a free information use request information transmitter 140a, a free information usage certificate purchase request information transmitter 150a, a free information usage certificate allocation information receiver 160a, a free information usage certificate purchase request information receiver 170a, a free information usage certificate allocation information transmitter 180a, a settlement requester 190a, a refund request information receiver 191a, and a refund processor 192a.

The free information usage certificate management database 110a is adapted to store information regarding the sales of free information usage certificates from at least one mobile contents provider associated with at least one communication company or from the communication company itself, sold from the communication company to one or more affiliated stores.

The free information usage certificate sale information contains respective identification information of the affiliated stores, the amount or number of free information usage certificates purchased from each communication company by each of the affiliated stores, the amount or number of the purchased free information usage certificates in stock, etc. The customer relationship management process can be performed on the basis of the sale information.

The free information use request information receiver 120a is adapted to receive, from a specific one of the affiliated store terminals 300, free information use request information containing a telephone number of a customer acquiring a free information usage certificate and affiliated store identification information.

Each affiliated store issues a free information usage certificate to a customer as a reward for his/her product purchase or service use and, using a corresponding one of the affiliated store terminals 300, inputs free information use request information with a telephone number of the customer acquiring the free information usage certificate to transmit it to the free information usage certificate management server 100. At this time, affiliated store identification information, such as a unique number set in the corresponding affiliated store terminal 300, is transmitted to the free information usage certificate management server 100 together with the free information use request information.

Alternatively, the free information use request information containing the telephone number of the customer acquiring the free information usage certificate may be inputted and transmitted to the free information usage certificate management server 100 using the customer terminal 400, not the corresponding affiliated store terminal 300.

Each of the affiliated store terminals 300 may be, for example, a dedicated terminal or personal computer installed in the corresponding affiliated store, or a mobile communication terminal or personal digital assistant (PDA) of the corresponding affiliated store.

The authentication processor 130a is adapted to search the sale information stored in the free information usage certificate management database 110a for sale information corresponding to the affiliated store identification information to determine whether the corresponding sale information is present in the stored sale information, and perform an authentication process based on the determination result.

The sale information stored in the free information usage certificate management database 110a contains respective identification information of the affiliated stores, the amount or number of free information usage certificates purchased from each communication company by each of the affiliated stores, the amount or number of the purchased free information usage certificates in stock, etc. The authentication processor 130a searches the stored sale information for the sale information corresponding to the affiliated store identification information transmitted from the specific affiliated store terminal 300, received by the free information use request information receiver 120a, to determine whether the corresponding sale information is present in the stored sale information, and performs the authentication process based on the determination result. In the authentication process, the authentication processor 130a outputs authentication information if the corresponding sale information is present in the stored sale information, and authentication failure information if the corresponding sale information is not present in the stored sale information.

This technique for searching the database and performing the authentication process based on the search result is well known to those skilled in the art and a detailed description thereof will thus be omitted.

The free information use request information transmitter 140a is adapted to transmit the free information use request information authenticated by the authentication processor 130a to the communication company server 200 so that the server 200 can deduct the amount of money corresponding to a free information usage fee allocated to the free information usage certificate acquired by the customer from communication fees to be charged to the customer's telephone number contained in the free information use request information.

That is, the free information use request information transmitter 140a transmits the free information use request information containing the customer's telephone number, authenticated by the authentication processor 130a, to the communication company server 200. A billing server of the communication company server 200 receives the free information use request information transmitted from the free information use request information transmitter 140a, deducts the amount of money corresponding to the free information usage fee allocated to the free information usage certificate acquired by the customer from an information usage fee in communication fees of the next term to be charged to the customer's telephone number contained in the free information use request information, and issues the resulting communication fee bill to the customer. As a result, the customer can benefit from a free information use service using the free information usage certificate as a reward for his/her online/offline product purchase or service use. This has the effect of reducing the customer's burden of communication cost, which leads to a more tangible reward.

On the other hand, provided that the customer acquiring the free information usage certificate does not use mobile contents information at all, the billing server of the communication company server 200 may instead deduct the amount of money corresponding to the free information usage certificate from a call fee in the customer's communication fees.

The technique for providing mobile contents from the mobile contents provider or the communication company itself over a mobile communication network and performing a billing process for the mobile contents provision is well known to those skilled in the art and a detailed description thereof will thus be omitted.

As stated above, according to the first embodiment of the present invention, the free information usage certificate management server 100 further includes the free information usage certificate purchase request information transmitter 150a and the free information usage certificate allocation information receiver 160a.

The free information usage certificate purchase request is information transmitter 150a is adapted to transmit free information usage certificate purchase request information to the communication company server 200.

In other words, the free information usage certificate management server 100 requests the purchase of free information usage certificates from the communication company online/offline in the resale scheme or cooperative purchase scheme. The offline purchase request can be made based on a contract, and the online purchase request can be made through the fact that the free information usage certificate purchase request information transmitter 150a transmits the free information usage certificate purchase request information to the communication company server 200.

The free information usage certificate allocation information receiver 160a is adapted to receive free information usage certificate allocation information based on the free information usage certificate purchase request information from the communication company server 200.

That is, if the free information usage certificate management server 100 transmits the free information usage certificate purchase request information to the communication company server 200 through the free information usage certificate purchase request information transmitter 150a, then the communication company server 200 receives the transmitted free information usage certificate purchase request information and transmits the free information usage certificate allocation information based on the received information to the free information usage certificate management server 100. Then, the free information usage certificate allocation information receiver 160a receives the free information usage certificate allocation information transmitted from the communication company server 200.

As stated above, according to the first embodiment of the present invention, the free information usage certificate management server 100 further includes the free information usage certificate purchase request information receiver 170a and the free information usage certificate allocation information transmitter 180a.

The free information usage certificate purchase request information receiver 170a is adapted to receive free information usage certificate purchase request information from each of the affiliated store terminals 300.

Each affiliated store desiring to provide free information usage certificates to customers requests the purchase of free information usage certificates of an amount corresponding to its demand from the free information usage certificate management server 100 online/offline. The offline purchase request can be made based on a contract, and the online purchase request can be made through the fact that each of the affiliated store terminals 300 transmits the free information usage certificate purchase request information to the free information usage certificate purchase request information receiver 170a.

The free information usage certificate allocation information transmitter 180a is adapted to transmit free information usage certificate allocation information based on the free information usage certificate purchase request information received by the free information usage certificate purchase request information receiver 170a to each of the affiliated store terminals 300.

Upon receiving the free information usage certificate purchase request information transmitted from each of the affiliated store terminals 300, the free information usage certificate management server 100 transmits the free information usage certificate allocation information based on the received information to the corresponding affiliated store terminal 300 to sell free information usage certificates to the corresponding affiliated store. The free information usage certificate management server 100 then stores information regarding the sales of the sold free information usage certificates in the free information usage certificate management database 110a.

As stated above, according to the first embodiment of the present invention, the free information usage certificate management server 100 further includes the settlement requester 190a.

The settlement requestor 190a is adapted to transmit settlement request information to the financial company server 500 to request it to settle the affiliated stores' accounts for the prices for purchases of the free information usage certificates, respectively, and then receive results of the settlements from the financial company server 500.

In other words, upon receiving the free information usage certificate purchase request information transmitted from each of the affiliated store terminals 300, the free information usage certificate management server 100 transmits a picture associated with settlement of a purchasing price corresponding to the received free information usage certificate purchase request information to the corresponding affiliated store terminal 300 to display it thereon. Thereafter, the settlement requestor 190a transmits settlement information inputted from the corresponding affiliated store terminal 300 to the financial company server 500 to request it to settle the corresponding affiliated store's account for the purchasing price, and then receives a result of the settlement from the financial company server 500.

This settlement process can be performed through an online account transfer or credit card settlement, and the settlement-related techniques are well known to those skilled in the art and a detailed description thereof will thus be omitted.

As stated above, according to the first embodiment of the present invention, the free information usage certificate management server 100 further includes the refund request information receiver 191a and the refund processor 192a.

The refund request information receiver 191a is adapted to receive refund request information containing a returned amount of the free information usage certificates and the affiliated store identification information from the specific affiliated store terminal 300.

In the case where some of the free information usage certificates purchased from the free information usage certificate management server 100 remain after being distributed to customers, each affiliated store can request a refund of the remaining free information usage certificates online/offline. For the online refund request, the refund request information transmitted from the specific affiliated store terminal 300 is received by the refund request information receiver 191a.

The refund processor 192a is adapted to, if the authentication processor 130a searches the sale information stored in the free information usage certificate management database 110a for the sale information corresponding to the affiliated store identification information to determine whether the corresponding sale information is present in the stored sale information, and authenticates the corresponding affiliated store as a result of the determination, request the financial company server 500 through the settlement requestor 190a to pay the corresponding affiliated store a refund of the returned free information usage certificate amount contained in the refund request information received by the refund request information receiver 191a, and update the free information usage certificate management database 110a on the basis of the refund request information.

That is, in response to the refund request information transmitted from the specific affiliated store terminal 300 and received by the refund request information receiver 191a, the refund processor 192a performs a refund process for the returned free information usage certificate amount after authentication by the authentication processor 130a. The authentication processor 130a searches the sale information stored in the free information usage certificate management database 110a for the sale information corresponding to the affiliated store identification information to determine whether the corresponding sale information is present in the stored sale information, and performs the authentication process based on the determination result. If the authentication processor 130a authenticates the corresponding affiliated store as a result of the determination, the refund processor 192a requests the financial company server 500 through the settlement requestor 190a to pay the corresponding affiliated store a refund of the returned free information usage certificate amount, and updates the free information usage certificate management database 110a on the basis of the refund request information.

On the other hand, it is preferable that a refund request and process between the free information usage certificate management server 100 and the communication company is carried out offline, and a description thereof will be omitted.

The communication company server 200 is adapted to allocate free information usage certificates to the free information usage certificate management server 100 and, in response to the free information use request information from the server 100, deduct the amount of money corresponding to the free information usage certificate acquired by the customer from an information usage fee in communication fees to be charged to the customer's telephone number contained in the free information use request information.

On the other hand, provided that the customer acquiring the free information usage certificate does not use mobile contents information at all, the billing server of the communication company server 200 may instead deduct the amount of money corresponding to the free information usage certificate from a call fee in the customer's communication fees.

Each of the affiliated store terminals 300 is adapted to transmit free information use request information with a customer's telephone number and affiliated store identification information for authentication to the free information usage certificate management server 100.

Each of the affiliated store terminals 300 is also adapted to transmit free information usage certificate purchase request information to the free information usage certificate management server 100 and receive free information usage certificate allocation information based on the free information usage certificate purchase request information from the free information usage certificate management server 100.

The customer terminal 400 is adapted to receive guide information about the free information use service from the free information usage certificate management server 100 and allow a corresponding customer to enjoy the free information use service (mobile contents service) free of charge using a free information usage certificate issued thereto.

The customer terminal 400 is preferably a wireless communication terminal such as a mobile telephone, PDA or etc. In this case, the free information usage certificate management server 100 may transmit the guide information about the free information use service to the wireless communication terminal in the form of a short message service (SMS) message.

The financial company server 500 is adapted to process the settlement associated with the free information usage certificate purchase request information from each of the affiliated store terminals.

That is, the free information usage certificate management server 100 receives the free information usage certificate purchase request information transmitted from each of the affiliated store terminals 300 and transmits the picture associated with the settlement of the purchasing price corresponding to the received free information usage certificate purchase request information to the corresponding affiliated store terminal 300 to display it thereon. Thereafter, the free information usage certificate management server 100 transmits the settlement information inputted from the corresponding affiliated store terminal 300 to the financial company server 500 to request it to settle the corresponding affiliated store's account for the purchasing price. In response to the settlement request, the financial company server 500 settles the corresponding affiliated store's account for the purchasing price and transmits the settlement result to the free information usage certificate management server 100.

The settlement process by the financial company server 500 can be performed through an online account transfer or credit card settlement, and the settlement-related techniques are well known to those skilled in the art and a detailed description thereof will thus be omitted.

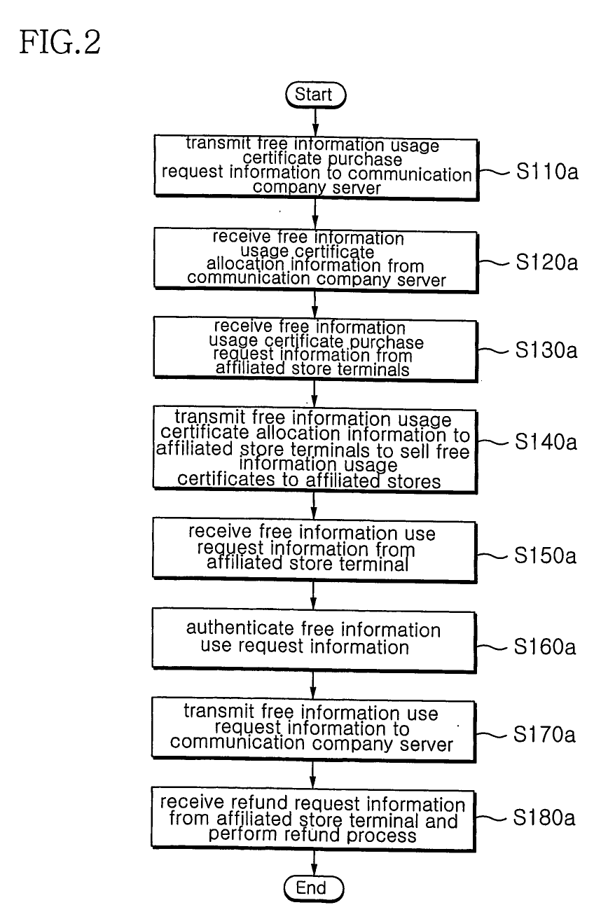

The operation of the free information usage certificate service system with the above-stated configuration according to the first embodiment of the present invention will hereinafter be described in detail with reference to FIG. 2.

FIG. 2 is a flow chart illustrating the operation of the free information usage certificate service system of FIG. 1.

First, at step S110a, the free information usage certificate purchase request information transmitter 150a in the free information usage certificate management server 100 transmits free information usage certificate purchase request information to the communication company server 200.

At step S120a, the free information usage certificate allocation information receiver 160a in the free information usage certificate management server 100 receives free information usage certificate allocation information based on the free information usage certificate purchase request information from the communication company server 200 and stores the received allocation information in the free information usage certificate management database 110a.

At step S130a, the free information usage certificate purchase request information receiver 170a in the free information usage certificate management server 100 receives free information usage certificate purchase request information from the affiliated store terminals 300, and the settlement requester 190a in the free information usage certificate management server 100 requests the financial company server 500 to settle the corresponding affiliated stores' accounts for free information usage certificate purchasing prices, and then receives results of the settlements from the financial company server 500.

At step S140a, the free information usage certificate allocation information transmitter 180a in the free information usage certificate management server 100 transmits free information usage certificate allocation information based on the free information usage certificate purchase request information received by the free information usage certificate purchase request information receiver 170a respectively to the affiliated store terminals 300 to sell free information usage certificates to the corresponding affiliated stores, and then stores information regarding the sales of the sold free information usage certificates in the free information usage certificate management database 110a.

At step S150a, the free information use request information receiver 120a in the free information usage certificate management server 100 receives, from a specific one of the affiliated store terminals 300, free information use request information containing a telephone number of a customer acquiring a free information usage certificate and affiliated store identification information.

At step S160a, the authentication processor 130a in the free information usage certificate management server 100 searches the sale information stored in the free information usage certificate management database 110a for sale information corresponding to the affiliated store identification information to determine whether the corresponding sale information is present in the stored sale information, and performs an authentication process based on the determination result.

At step S170a, the free information use request information transmitter 140a in the free information usage certificate management server 100 transmits the free information use request information authenticated by the authentication processor 130a to the communication company server 200 so that the server 200 can deduct the amount of money corresponding to a free information usage fee allocated to the free information usage certificate acquired by the customer from communication fees to be charged to the customer's telephone number contained in the free information use request information.

At step S180a, the refund request information receiver 191a in the free information usage certificate management server 100 receives refund request information and the affiliated store identification information from the specific affiliated store terminal 300. If the authentication processor 130a searches the sale information stored in the free information usage certificate management database 110a for the sale information corresponding to the affiliated store identification information to determine whether the corresponding sale information is present in the stored sale information, and authenticates the corresponding affiliated store as a result of the determination, the refund processor 192a in the free information usage certificate management server 100 requests the financial company server 500 through the settlement requester 190a to pay the corresponding affiliated store a refund of a returned amount of the free information usage certificates contained in the refund request information received by the refund request information receiver 191a, and updates the free information usage certificate management database 110a on the basis of the refund request information.

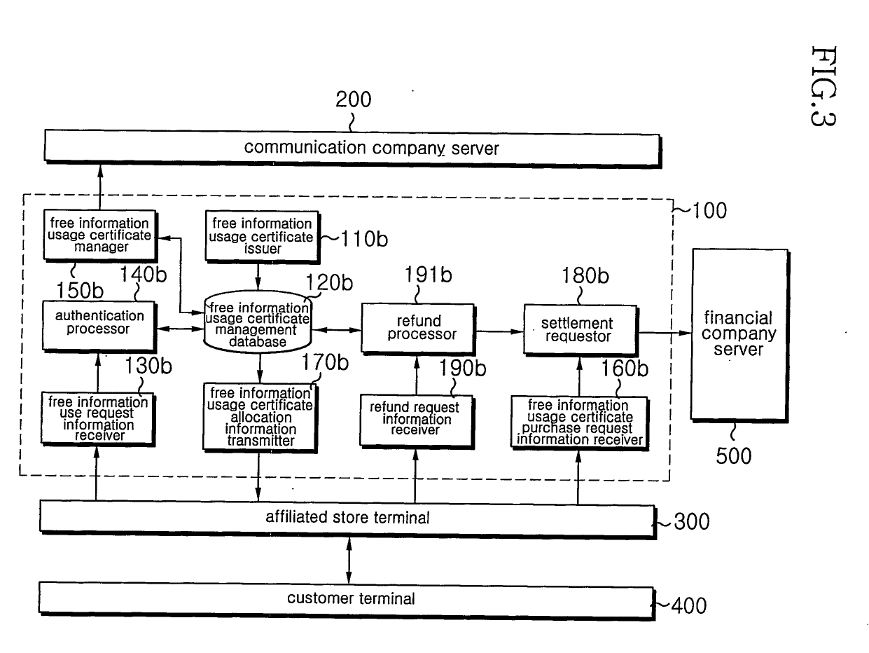

FIG. 3 is a block diagram showing the configuration of a free information usage certificate service system according to a second embodiment of the present invention.

In the free information usage certificate service system according to the second embodiment, a free information usage certificate management server issues free information usage certificates for free use of mobile contents provided from at least one mobile contents provider associated therewith, receives free information usage certificate purchase requests from affiliated stores and distributes the free information usage certificates to the affiliated stores in response to the received purchase requests, and the affiliated stores provide the distributed certificates to customers. At this time, a manager of the free information usage certificate management server may online/offline issue and sell the free information usage certificates to the affiliated stores in the form of coupons.

The affiliated stores can provide the free information usage certificates to the customers as rewards for their product purchases or service use, or free of charge to entice the customers for the purpose of gaining future profits therefrom. Therefore, the free information usage certificates can be provided online/offline to the customers with or without compensation for many purposes throughout society.

The free information usage certificates can be provided in various forms such as offline coupons containing a provider's advertisement, or electronic barcodes in digital data format. That is, the free information usage certificates can be provided in various ways irrespective of form.

With reference to FIG. 3, the free information usage certificate service system according to the second embodiment of the present invention comprises a free information usage certificate management server 100, at least one communication company server 200, one or more affiliated store terminals 300, at least one customer terminal 400 and at least one financial company server 500.

The free information usage certificate management server 100 acts to issue free information usage certificates for free use of mobile contents provided from at least one mobile contents provider associated therewith, sell the issued free information usage certificates to affiliated stores, store information regarding the sales of the free information usage certificates, and perform a customer relationship management process based on the sale information.

In detail, the free information usage certificate management server 100 includes a free information usage certificate issuer 110b, a free information usage certificate management database 120b, a free information use request information receiver 130b, an authentication processor 140b, and a free information usage certificate manager 150b.

The free information usage certificate issuer 110b is adapted to issue free information usage certificates for free use of mobile contents provided from at least one mobile contents provider associated with the free information usage certificate management server 100.

The free information usage certificate management database 120b is adapted to store information regarding the issuance of the free information usage certificates from the free information usage certificate issuer 110b and information regarding the sales of the free information usage certificates to one or more affiliated stores.

The free information usage certificate sale information contains respective identification information of the affiliated stores, the amount or number of free information usage certificates purchased by each of the affiliated stores, the amount or number of the purchased free information usage certificates in stock, etc. The customer relationship management process can be performed on the basis of the sale information.

The free information use request information receiver 130b is adapted to receive, from a specific one of the affiliated store terminals 300, free information use request information containing a telephone number of a customer acquiring a free information usage certificate and affiliated store identification information.

Each affiliated store issues a free information usage certificate to a customer as a reward for his/her product purchase or service use and, using a corresponding one of the affiliated store terminals 300, inputs free information use request information with a telephone number of the customer acquiring the free information usage certificate to transmit it to the free information usage certificate management server 100. At this time, affiliated store identification information, such as a unique number set in the corresponding affiliated store terminal 300, is transmitted to the free information usage certificate management server 100 together with the free information use request information.

As an alternative, the free information use request information containing the telephone number of the customer acquiring the free information usage certificate may be inputted and transmitted to the free information usage certificate management server 100 using the customer terminal 400, not the corresponding affiliated store terminal 300.

Each of the affiliated store terminals 300 may be, for example, a dedicated terminal or personal computer installed in the corresponding affiliated store, or a mobile communication terminal or PDA of the corresponding affiliated store.

The authentication processor 140b is adapted to search the sale information stored in the free information usage certificate management database 120b for sale information corresponding to the affiliated store identification information to determine whether the corresponding sale information is present in the stored sale information, and perform an authentication process based on the determination result. The authentication processor 140b also stores information regarding the provision of the free information usage certificate to the customer in the free information usage certificate management database 120b.

The sale information stored in the free information usage certificate management database 120b contains respective identification information of the affiliated stores, the amount or number of free information usage certificates purchased by each of the affiliated stores, the amount or number of the purchased free information usage certificates in stock, etc. The authentication processor 140b searches the stored sale information for the sale information corresponding to the affiliated store identification information transmitted from the specific affiliated store terminal 300, received by the free information use request information receiver 130b, to determine whether the corresponding sale information is present in the stored sale information, and performs the authentication process based on the determination result. In the authentication process, if the corresponding sale information is present in the stored sale information, the authentication processor 140b stores information regarding the provision of the free information usage certificate to the customer in the free information usage certificate management database 120b and outputs authentication information. However, if the corresponding sale information is not present in the stored sale information, the authentication processor 140b outputs authentication failure information.

This technique for searching the database and performing the authentication process based on the search result is well known to those skilled in the art and a detailed description thereof will thus be omitted.

The free information usage certificate manager 150b is adapted to request and receive information usage records of the customer acquiring the free information usage certificate, from the communication company server 200, calculate an information usage fee for use of the mobile contents provided from the associated mobile contents provider, to which the free information usage certificate acquired by the customer is applicable, from the received information usage records, and deduct the calculated information usage fee from a free information usable fee contained in the free information usage certificate provision information stored in the free information usage certificate management database 120b to update the free information usable fee. The free information usage certificate manager 150b also requests the communication company server 200 to deduct the calculated information usage fee from an information usage fee to be charged to the customer's telephone number.

That is, the free information usage certificate manager 150b requests and receives information usage records of the customer acquiring the free information usage certificate, authenticated by the authentication processor 140b, from the communication company server 200 periodically every month. The free information usage certificate manager 150b then calculates, from the received information usage records, an information usage fee that can be paid with the free information usage certificate acquired by the customer, namely, an information usage fee for use of the mobile contents provided from the associated mobile contents provider, to which the free information usage certificate acquired by the customer is applicable. Subsequently, the free information usage certificate manager 150b deducts the calculated information usage fee from a free information usable fee contained in the free information usage certificate provision information stored in the free information usage certificate management database 120b to update the free information usable fee. The free information usage certificate manager 150b also transmits deduction request information to the communication company server 200 to request it to deduct the calculated information usage fee from an information usage fee to be charged to the customer's telephone number.

A billing server of the communication company server 200 receives the deduction request information transmitted from the free information usage certificate manager 150b, deducts the amount of money that can be paid with the free information usage certificate acquired by the customer from an information usage fee in communication fees of the next term to be charged to the customer's telephone number, and issues the resulting communication fee bill to the customer. As a result, the customer can benefit from a free information use service using the free information usage certificate as a reward for his/her online/offline product purchase or service use. This has the effect of reducing the customer's burden of communication cost, which leads to a more tangible reward.

The technique for providing the mobile contents from the associated mobile contents provider over a mobile communication network and performing a billing process for the contents provision is well known to those skilled in the art and a detailed description thereof will thus be omitted.

According to the second embodiment of the present invention, the free information usage certificate management server 100 further includes a free information usage certificate purchase request information receiver 160b and a free information usage certificate allocation information transmitter 170b.

The free information usage certificate purchase request information receiver 160b is adapted to receive free information usage certificate purchase request information from each of the affiliated store terminals 300.

Each affiliated store desiring to provide free information usage certificates to customers requests the purchase of free information usage certificates of an amount corresponding to its demand from the free information usage certificate management server 100 online/offline. The offline purchase request can be made based on a contract, and the online purchase request can be made through the fact that each of the affiliated store terminals 300 transmits the free information usage certificate purchase request information to the free information usage certificate purchase request information receiver 160b.

The free information usage certificate allocation information transmitter 170b is adapted to transmit free information usage certificate allocation information based on the free information usage certificate purchase request information received by the free information usage certificate purchase request information receiver 160b to each of the affiliated store terminals 300.

If the free information usage certificate management server 100 receives the free information usage certificate purchase request information transmitted from each of the affiliated store terminals 300, then it transmits the free information usage certificate allocation information based on the received information to the corresponding affiliated store terminal 300 to sell free information usage certificates to the corresponding affiliated store. The free information usage certificate management server 100 then stores information regarding the sales of the sold free information usage certificates in the free information usage certificate management database 120b.

According to the second embodiment of the present invention, the free information usage certificate management server 100 further includes a settlement requester 180b.

The settlement requestor 180b is adapted to transmit settlement request information to the financial company server 500 to request it to settle the affiliated stores' accounts for the prices for purchases of the free information usage certificates, respectively, and then receive results of the settlements from the financial company server 500.

That is, upon receiving the free information usage certificate purchase request information transmitted from each of the affiliated store terminals 300, the free information usage certificate management server 100 transmits a picture associated with settlement of a purchasing price corresponding to the received free information usage certificate purchase request information to the corresponding affiliated store terminal 300 to display it thereon. Thereafter, the settlement requestor 180b transmits settlement information inputted from the corresponding affiliated store terminal 300 to the financial company server 500 to request it to settle the corresponding affiliated store's account for the purchasing price, and then receives a result of the settlement from the financial company server 500.

This settlement process can be performed through an online account transfer or credit card settlement, and the settlement-related techniques are well known to those skilled in the art and a detailed description thereof will thus be omitted.

According to the second embodiment of the present invention, the free information usage certificate management server 100 further includes a refund request information receiver 190b and a refund processor 191b.

The refund request information receiver 190b is adapted to receive refund request information containing a returned amount of the free information usage certificates and the affiliated store identification information from the specific affiliated store terminal 300.

Where some of the free information usage certificates purchased from the free information usage certificate management server 100 remain after being distributed to customers, each affiliated store can request a refund of the remaining free information usage certificates online/offline. For the online refund request, the refund request information transmitted from the specific affiliated store terminal 300 is received by the refund request information receiver 190b.

The refund processor 191b is adapted to, if the authentication processor 140b searches the sale information stored in the free information usage certificate management database 120b for the sale information corresponding to the affiliated store identification information to determine whether the corresponding sale information is present in the stored sale information, and authenticates the corresponding affiliated store as a result of the determination, request the financial company server 500 through the settlement requester 180b to pay the corresponding affiliated store a refund of the returned free information usage certificate amount contained in the refund request information received by the refund request information receiver 190b, and update the free information usage certificate management database 120b on the basis of the refund request information.

That is, in response to the refund request information transmitted from the specific affiliated store terminal 300 and received by the refund request information receiver 190b, the refund processor 191b performs a refund process for the returned free information usage certificate amount after authentication by the authentication processor 140b. The authentication processor 140b searches the sale information stored in the free information usage certificate management database 120b for the sale information corresponding to the affiliated store identification information to determine whether the corresponding sale information is present in the stored sale information, and performs the authentication process based on the determination result. If the authentication processor 140b authenticates the corresponding affiliated store as a result of the determination, the refund processor 191b requests the financial company server 500 through the settlement requestor 180b to pay the corresponding affiliated store a refund of the returned free information usage certificate amount, and updates the free information usage certificate management database 120b on the basis of the refund request information.

The communication company server 200 is adapted to receive the request for the information usage records of the customer acquiring the free information usage certificate, from the free information usage certificate management server 100, and transmit the information usage records to the server 100 in response to the received request. The communication company server 200 also deducts the information usage fee calculated by the free information usage certificate manager 150b from an information usage fee to be charged to the customer's telephone number in response to the deduction request information from the free information usage certificate management server 100.

Each of the affiliated store terminals 300 is adapted to transmit free information use request information with a customer's telephone number and affiliated store identification information for authentication to the free information usage certificate management server 100.

Each of the affiliated store terminals 300 is also adapted to transmit free information usage certificate purchase request information to the free information usage certificate management server 100 and receive free information usage certificate allocation information based on the free information usage certificate purchase request information from the free information usage certificate management server 100.

The customer terminal 400 is adapted to receive guide information about the free information use service from the free information usage certificate management server 100 and allow a corresponding customer to enjoy the free information use service (mobile contents service) free of charge using a free information usage certificate issued thereto.

The customer terminal 400 is preferably a wireless communication terminal such as a mobile telephone, PDA or etc. In this case, the free information usage certificate management server 100 may transmit the guide information about the free information use service to the wireless communication terminal in the form of an SMS message.

The financial company server 500 is adapted to process the settlement associated with the free information usage certificate purchase request information from each of the affiliated store terminals.

That is, the free information usage certificate management server 100 receives the free information usage certificate purchase request information transmitted from each of the affiliated store terminals 300 and transmits the picture associated with the settlement of the purchasing price corresponding to the received free information usage certificate purchase request information to the corresponding affiliated store terminal 300 to display it thereon. Thereafter, the free information usage certificate management server 100 transmits the settlement information inputted from the corresponding affiliated store terminal 300 to the financial company server 500 to request it to settle the corresponding affiliated store's account for the purchasing price. In response to the settlement request, the financial company server 500 settles the corresponding affiliated store's account for the purchasing price and transmits the settlement result to the free information usage certificate management server 100.

The settlement process by the financial company server 500 can be performed through an online account transfer or credit card settlement, and the settlement-related techniques are well known to those skilled in the art and a detailed description thereof will thus be omitted.

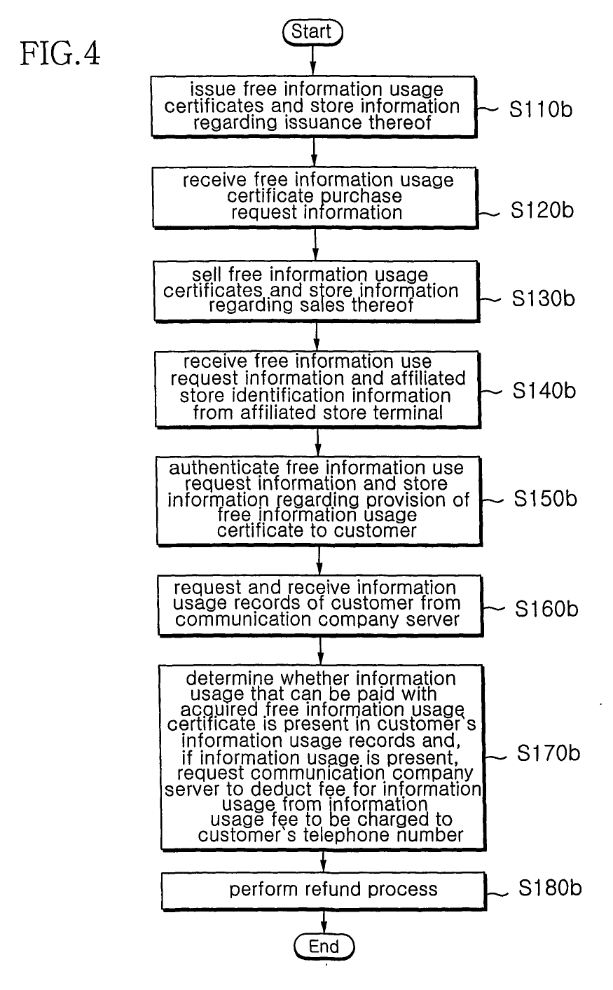

The operation of the free information usage certificate service system with the above-stated configuration according to the second embodiment of the present invention will hereinafter be described in detail with reference to FIG. 4.

FIG. 4 is a flow chart illustrating the operation of the free information usage certificate service system of FIG. 3.

First, at step S110b, the free information usage certificate issuer 110b in the free information usage certificate management server 100 issues free information usage certificates for free use of mobile contents provided from at least one mobile contents provider associated with the server 100 and stores information regarding the issuance of the free information usage certificates in the free information usage certificate management database 120b.

At step S120b, the free information usage certificate purchase request information receiver 160b in the free information usage certificate management server 100 receives free information usage certificate purchase request information from the affiliated store terminals 300, and the settlement requestor 180b in the free information usage certificate management server 100 requests the financial company server 500 to settle the corresponding affiliated stores' accounts for free information usage certificate purchasing prices, and then receives results of the settlements from the financial company server 500.

At step S130b, the free information usage certificate allocation information transmitter 170b in the free information usage certificate management server 100 transmits free information usage certificate allocation information based on the free information usage certificate purchase request information received by the free information usage certificate purchase request information receiver 160b respectively to the affiliated store terminals 300 to sell free information usage certificates to the corresponding affiliated stores, and then stores information regarding the sales of the sold free information usage certificates in the free information usage certificate management database 120b.

At step S140b, the free information use request information receiver 130b in the free information usage certificate management server 100 receives, from a specific one of the affiliated store terminals 300, free information use request information containing a telephone number of a customer acquiring a free information usage certificate and affiliated store identification information.

At step S150b, the authentication processor 140b in the free information usage certificate management server 100 searches the sale information stored in the free information usage certificate management database 120b for sale information corresponding to the affiliated store identification information to determine whether the corresponding sale information is present in the stored sale information, and performs an authentication process based on the determination result. The authentication processor 140b also stores information regarding the provision of the free information usage certificate to the customer in the free information usage certificate management database 120b.

The customer uses various contents provided from a mobile contents provider server using the customer terminal 400, and the billing server of the communication company server 200 includes an information usage fee for the contents use in communication fees to be charged to the customer's telephone number and stores records of the communication fees including the information usage fee.

At step S160b, the free information usage certificate manager 150b in the free information usage certificate management server 100 requests and receives information usage records of the customer acquiring the free information usage certificate, from the communication company server 200, with reference to the free information usage certificate provision information stored in the free information usage certificate management database 120b.

At step S170b, the free information usage certificate manager 150b in the free information usage certificate management server 100 determines whether an information usage that can be paid with the free information usage certificate acquired by the customer is present in the received information usage records. If the information usage is determined to be present in the received information usage records, the free information usage certificate manager 150b calculates a fee for the information usage, and deducts the calculated information usage fee from a free information usable fee contained in the free information usage certificate provision information stored in the free information usage certificate management database 120b to update the free information usable fee. The free information usage certificate manager 150b further requests the communication company server 200 to deduct the calculated information usage fee from an information usage fee to be charged to the customer's telephone number.

At step S180b, the refund request information receiver 190b in the free information usage certificate management server 100 receives refund request information and the affiliated store identification information from the specific affiliated store terminal 300. If the authentication processor 140b searches the sale information stored in the free information usage certificate management database 120b for the sale information corresponding to the affiliated store identification information to determine whether the corresponding sale information is present in the stored sale information, and authenticates the corresponding affiliated store as a result of the determination, the refund processor l91b in the free information usage certificate management server 100 requests the financial company server 500 through the settlement requester 180b to pay the corresponding affiliated store a refund of a returned amount of the free information usage certificates contained in the refund request information received by the refund request information receiver 190b, and updates the free information usage certificate management database 120b on the basis of the refund request information.

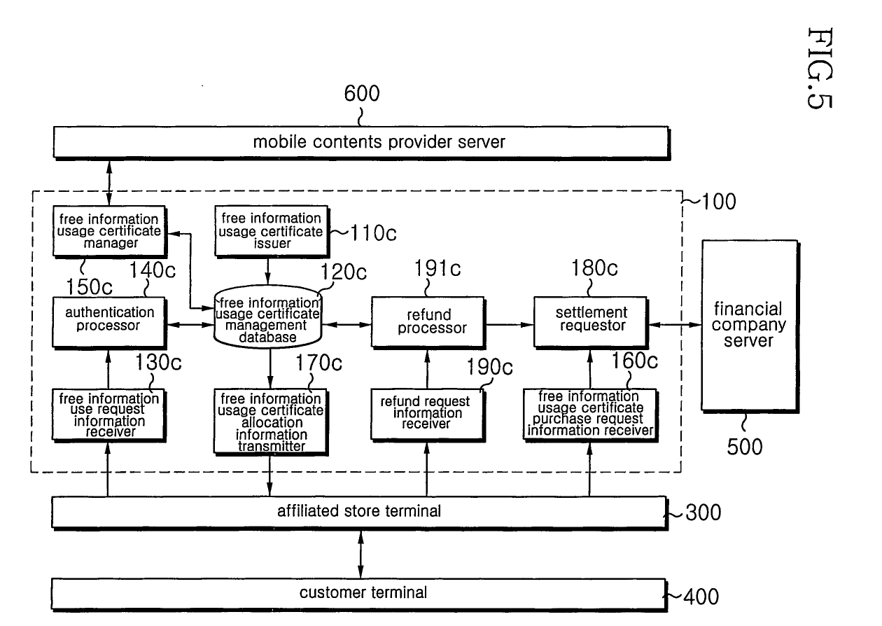

FIG. 5 is a block diagram showing the configuration of a free information usage certificate service system according to a third embodiment of the present invention.

In the free information usage certificate service system according to the third embodiment, a free information usage certificate management server issues free information usage certificates for free use of mobile contents provided from at least one mobile contents provider associated therewith, receives free information usage certificate purchase requests from affiliated stores and distributes the free information usage certificates to the affiliated stores in response to the received purchase requests, and the affiliated stores provide the distributed certificates to customers. At this time, a manager of the free information usage certificate management server may online/offline issue and sell the free information usage certificates to the affiliated stores in the form of coupons.

The affiliated stores can provide the free information usage certificates to the customers as rewards for their product purchases or service use, or free of charge to entice the customers for the purpose of gaining future profits therefrom. Therefore, the free information usage certificates can be provided online/offline to the customers with or without compensation for many purposes throughout society.

The free information usage certificates can be provided in various forms such as offline coupons containing a provider's advertisement, or electronic barcodes in digital data format. That is, the free information usage certificates can be provided in various ways irrespective of form.

With reference to FIG. 5, the free information usage certificate service system according to the third embodiment of the present invention comprises a free information usage certificate management server 100, at least one mobile contents provider server 600, one or more affiliated store terminals 300, at least one customer terminal 400 and at least one financial company server 500.

The free information usage certificate management server 100 acts to issue free information usage certificates for free use of mobile contents provided from at least one mobile contents provider associated therewith, sell the issued free information usage certificates to affiliated stores, store information regarding the sales of the free information usage certificates, and perform a customer relationship management process based on the sale information.

In detail, the free information usage certificate management server 100 includes a free information usage certificate issuer 110c, a free information usage certificate management database 120c, a free information use request information receiver 130c, an authentication processor 140c, and a free information usage certificate manager 150c.

The free information usage certificate issuer 110c is adapted to issue free information usage certificates for free use of mobile contents provided from at least one mobile contents provider associated with the free information usage certificate management server 100.

The free information usage certificate management database 120c is adapted to store information regarding the issuance of the free information usage certificates from the free information usage certificate issuer 110c and information regarding the sales of the free information usage certificates to one or more affiliated stores.

The free information usage certificate sale information contains respective identification information of the affiliated stores, the amount or number of free information usage certificates purchased by each of the affiliated stores, the amount or number of the purchased free information usage certificates in stock, etc. The customer relationship management process can be performed on the basis of the sale information.

The free information use request information receiver 130c is adapted to receive, from a specific one of the affiliated store terminals 300, free information use request information containing a telephone number of a customer acquiring a free information usage certificate and affiliated store identification information.

Each affiliated store issues a free information usage certificate to a customer as a reward for his/her product purchase or service use and, using a corresponding one of the affiliated store terminals 300, inputs free information use request information with a telephone number of the customer acquiring the free information usage certificate to transmit it to the free information usage certificate management server 100. At this time, affiliated store identification information, such as a unique number set in the corresponding affiliated store terminal 300, is transmitted to the free information usage certificate management server 100 together with the free information use request information.

Alternatively, the free information use request information containing the telephone number of the customer acquiring the free information usage certificate may be inputted and transmitted to the free information usage certificate management server 100 using the customer terminal 400, not the corresponding affiliated store terminal 300.

Each of the affiliated store terminals 300 may be, for example, a dedicated terminal or personal computer installed in the corresponding affiliated store, or a mobile communication terminal or PDA of the corresponding affiliated store.

The authentication processor 140c is adapted to search the sale information stored in the free information usage certificate management database 120c for sale information corresponding to the affiliated store identification information to determine whether the corresponding sale information is present in the stored sale information, and perform an authentication process based on the determination result. The authentication processor 140c also stores information regarding the provision of the free information usage certificate to the customer in the free information usage certificate management database 120c.

The sale information stored in the free information usage certificate management database 120c contains respective identification information of the affiliated stores, the amount or number of free information usage certificates purchased by each of the affiliated stores, the amount or number of the purchased free information usage certificates in stock, etc. The authentication processor 140c searches the stored sale information for the sale information corresponding to the affiliated store identification information transmitted from the specific affiliated store terminal 300, received by the free information use request information receiver 130c, to determine whether the corresponding sale information is present in the stored sale information, and performs the authentication process based on the determination result. In the authentication process, if the corresponding sale information is present in the stored sale information, the authentication processor 140c stores information regarding the provision of the free information usage certificate to the customer in the free information usage certificate management database 120c and outputs authentication information. However, if the corresponding sale information is not present in the stored sale information, the authentication processor 140c outputs authentication failure information.

This technique for searching the database and performing the authentication process based on the search result is well known to those skilled in the art and a detailed description thereof will thus be omitted.

The free information usage certificate manager 150c is adapted to receive free information usage certificate payment request information containing the customer's telephone number from the mobile contents provider server 600, search the free information usage certificate management database 120c for free information usage certificate provision information corresponding to the customer's telephone number contained in the received free information usage certificate payment request information to determine whether the corresponding free information usage certificate provision information is present in the database 120c, and, if the corresponding provision information is present in the database 120c, deduct an information usage fee for contents used by the customer from a free information usable fee contained in the corresponding provision information to update the free information usable fee. The free information usage certificate manager 150c also adds the information usage fee for the contents used by the customer to the total free information usage fee provided from the mobile contents provider, stored in the free information usage certificate management database 120c, to update the total free information usage fee.

In other words, if the customer accesses the mobile contents provider server 600 and selects a payment based on the acquired free information usage certificate to use contents provided from the server 600, then the server 600 transmits free information usage certificate payment request information with the customer's telephone number to the free information usage certificate management server 100. Then, the free information usage certificate manager 150c receives the free information usage certificate payment request information transmitted from the mobile contents provider server 600, and searches the free information usage certificate management database 120c for free information usage certificate provision information corresponding to the customer's telephone number contained in the received free information usage certificate payment request information to determine whether the corresponding free information usage certificate provision information is present in the database 120c. If the corresponding free information usage certificate provision information is present in the free information usage certificate management database 120c, the free information usage certificate manager 150c deducts an information usage fee for the contents used by the customer from a free information usable fee contained in the corresponding provision information to update the free information usable fee. The free information usage certificate manager 150c also adds the information usage fee for the contents used by the customer to the total free information usage fee provided from the mobile contents provider, stored in the free information usage certificate management database 120c, to update the total free information usage fee.

The mobile contents provider associated with the free information usage certificate management server 100 monthly demands and receives payment from the free information usage certificate management server 100 for a specified amount of money corresponding to the total free information usage fee for free use of its contents by customers using free information usage certificates. Therefore, the customer can benefit from a free information use service using the acquired free information usage certificate as a reward for his/her online/offline product purchase or service use. This has the effect of reducing the customer's burden of information usage fee, which leads to a more tangible reward.

According to the third embodiment of the present invention, the free information usage certificate management server 100 further includes a free information usage certificate purchase request information receiver 160c and a free information usage certificate allocation information transmitter 170c.

The free information usage certificate purchase request information receiver 160c is adapted to receive free information usage certificate purchase request information from each of the affiliated store terminals 300.

Each affiliated store desiring to provide free information usage certificates to customers requests the purchase of free information usage certificates of an amount corresponding to its demand from the free information usage certificate management server 100 online/offline. The offline purchase request can be made based on a contract, and the online purchase request can be made through the fact that each of the affiliated store terminals 300 transmits the free information usage certificate purchase request information to the free information usage certificate purchase request information receiver 160c.

The free information usage certificate allocation information transmitter 170c is adapted to transmit free information usage certificate allocation information based on lo the free information usage certificate purchase request information received by the free information usage certificate purchase request information receiver 160c to each of the affiliated store terminals 300.

Upon receiving the free information usage certificate purchase request information transmitted from each of the affiliated store terminals 300, the free information usage certificate management server 100 transmits the free information usage certificate allocation information based on the received information to the corresponding affiliated store terminal 300 to sell free information usage certificates to the corresponding affiliated store. The free information usage certificate management server 100 then stores information regarding the sales of the sold free information usage certificates in the free information usage certificate management database 120c.

According to the third embodiment of the present invention, the free information usage certificate management server 100 further includes a settlement requester 180c.

The settlement requestor 180c is adapted to transmit settlement request information to the financial company server 500 to request it to settle the affiliated stores' accounts for the prices for purchases of the free information usage certificates, respectively, and then receive results of the settlements from the financial company server 500.

That is, upon receiving the free information usage certificate purchase request information transmitted from each of the affiliated store terminals 300, the free information usage certificate management server 100 transmits a picture associated with settlement of a purchasing price corresponding to the received free information usage certificate purchase request information to the corresponding affiliated store terminal 300 to display it thereon. Thereafter, the settlement requestor 180c transmits settlement information inputted from the corresponding affiliated store terminal 300 to the financial company server 500 to request it to settle the corresponding affiliated store's account for the purchasing price, and then receives a result of the settlement from the financial company server 500.

This settlement process can be performed through an online account transfer or credit card settlement, and the settlement-related techniques are well known to those skilled in the art and a detailed description thereof will thus be omitted.

According to the third embodiment of the present invention, the free information usage certificate management server 100 further includes a refund request information receiver 190c and a refund processor 191c.

The refund request information receiver 190c is adapted to receive refund request information containing a returned amount of the free information usage certificates and the affiliated store identification information from the specific affiliated store terminal 300.

Where some of the free information usage certificates purchased from the free information usage certificate management server 100 remain after being distributed to customers, each affiliated store can request a refund of the remaining free information usage certificates online/offline. For the online refund request, the refund request information transmitted from the specific affiliated store terminal 300 is received by the refund request information receiver 190c.

The refund processor 191c is adapted to, if the authentication processor 140c searches the sale information stored in the free information usage certificate management database 120c for the sale information corresponding to the affiliated store identification information to determine whether the corresponding sale information is present in the stored sale information, and authenticates the corresponding affiliated store as a result of the determination, request the financial company server 500 through the settlement requestor 180c to pay the corresponding affiliated store a refund of the returned free information usage certificate amount contained in the refund request information received by the refund request information receiver 190c, and update the free information usage certificate management database 120c on the basis of the refund request information.

That is, in response to the refund request information transmitted from the specific affiliated store terminal 300 and received by the refund request information receiver 190c, the refund processor 191c performs a refund process for the returned free information usage certificate amount after authentication by the authentication processor 140c. The authentication processor 140c searches the sale information stored in the free information usage certificate management database 120c for the sale information corresponding to the affiliated store identification information to determine whether the corresponding sale information is present in the stored sale information, and performs the authentication process based on the determination result. If the authentication processor 140c authenticates the corresponding affiliated store as a result of the determination, the refund processor 191c requests the financial company server 500 through the settlement requestor 180c to pay the corresponding affiliated store a refund of the returned free information usage certificate amount, and updates the free information usage certificate management database 120c on the basis of the refund request information.

The mobile contents provider server 600 is adapted to transmit records of free use of its contents by customers to the free information usage certificate management server 100 and request the server 100 to pay a specified amount of money corresponding to the provided total free information usage fee.

Each of the affiliated store terminals 300 is adapted to transmit free information use request information with a customer's telephone number and affiliated store identification information for authentication to the free information usage certificate management server 100.

Each of the affiliated store terminals 300 is also adapted to transmit free information usage certificate purchase request information to the free information usage certificate management server 100 and receive free information usage certificate allocation information based on the free information usage certificate purchase request information from the free information usage certificate management server 100.

The customer terminal 400 is adapted to receive guide information about the free information use service from the free information usage certificate management server 100 and allow a corresponding customer to enjoy the free information use service (mobile contents service) provided from the mobile contents provider server 600 free of charge using a free information usage certificate issued thereto.

The customer terminal 400 is preferably a wireless communication terminal such as a mobile telephone, PDA or etc. In this case, the free information usage certificate management server 100 may transmit the guide information about the free information use service to the wireless communication terminal in the form of an SMS message.

The financial company server 500 is adapted to process the settlement associated with the free information usage certificate purchase request information from each of the affiliated store terminals.

That is, the free information usage certificate management server 100 receives the free information usage certificate purchase request information transmitted from each of the affiliated store terminals 300 and transmits the picture associated with the settlement of the purchasing price corresponding to the received free information usage certificate purchase request information to the corresponding affiliated store terminal 300 to display it thereon. Thereafter, the free information usage certificate management server 100 transmits the settlement information inputted from the corresponding affiliated store terminal 300 to the financial company server 500 to request it to settle the corresponding affiliated store's account for the purchasing price. In response to the settlement request, the financial company server 500 settles the corresponding affiliated store's account for the purchasing price and transmits the settlement result to the free information usage certificate management server 100.

The settlement process by the financial company server 500 can be performed through an online account transfer or credit card settlement, and the settlement-related techniques are well known to those skilled in the art and a detailed description thereof will thus be omitted.

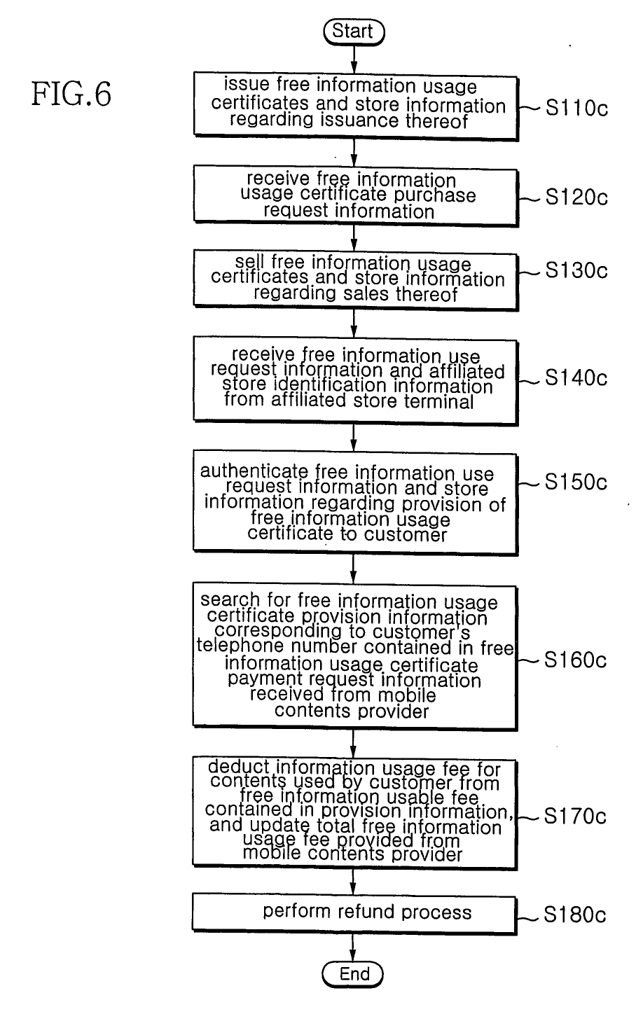

The operation of the free information usage certificate service system with the above-stated configuration according to the third embodiment of the present invention will hereinafter be described in detail with reference to FIG. 6.

FIG. 6 is a flow chart illustrating the operation of the free information usage certificate service system of FIG. 5.

First, at step S110c, the free information usage certificate issuer 110c in the free information usage certificate management server 100 issues free information usage certificates for free use of mobile contents provided from at least one mobile contents provider associated with the server 100 and stores information regarding the issuance of the free information usage certificates in the free information usage certificate management database 120c.

At step S120c, the free information usage certificate purchase request information receiver 160c in the free information usage certificate management server 100 receives free information usage certificate purchase request information from the affiliated store terminals 300, and the settlement requestor 180c in the free information usage certificate management server 100 requests the financial company server 500 to settle the corresponding affiliated stores' accounts for free information usage certificate purchasing prices, and then receives results of the settlements from the financial company server 500.

At step S130c, the free information usage certificate allocation information transmitter 170c in the free information usage certificate management server 100 transmits free information usage certificate allocation information based on the free information usage certificate purchase request information received by the free information usage certificate purchase request information receiver 160c respectively to the affiliated store terminals 300 to sell free information usage certificates to the corresponding affiliated stores, and then stores information regarding the sales of the sold free information usage certificates in the free information usage certificate management database 120c.

At step S140c, the free information use request information receiver 130c in the free information usage certificate management server 100 receives, from a specific one of the affiliated store terminals 300, free information use request information containing a telephone number of a customer acquiring a free information usage certificate and affiliated store identification information.

At step S150c, the authentication processor 140c in the free information usage certificate management server 100 searches the sale information stored in the free information usage certificate management database 120c for sale information corresponding to the affiliated store identification information to determine whether the corresponding sale information is present in the stored sale information, and performs an authentication process based on the determination result. The authentication processor 140c also stores information regarding the provision of the free information usage certificate to the customer in the free information usage certificate management database 120c.

The customer uses various contents provided from the mobile contents provider server 600 using the customer terminal 400. If the customer selects a payment based on the acquired free information usage certificate to pay a fee for the contents use, the mobile contents provider server 600 transmits free information usage certificate payment request information with the customer's telephone number to the free information usage certificate management server 100.

At step S160c, the free information usage certificate manager 150c in the free information usage certificate management server 100 receives the free information usage certificate payment request information transmitted from the mobile contents provider server 600, and searches the free information usage certificate management database 120c for free information usage certificate provision information corresponding to the customer's telephone number contained in the received free information usage certificate payment request information to determine whether the corresponding free information usage certificate provision information is present in the database 120c.

At step S170c, if the corresponding free information usage certificate provision information is present in the free information usage certificate management database 120c, the free information usage certificate manager 150c in the free information usage certificate management server 100 deducts an information usage fee for the contents used by the customer from a free information usable fee contained in the corresponding provision information to update the free information usable fee. The free information usage certificate manager 150c also adds the information usage fee for the contents used by the customer to the total free information usage fee provided from the mobile contents provider to update the total free information usage fee.

At step S180c, the refund request information receiver 190c in the free information usage certificate management server 100 receives refund request information and the affiliated store identification information from the specific affiliated store terminal 300. If the authentication processor 140c searches the sale information stored in the free information usage certificate management database 120c for the sale information corresponding to the affiliated store identification information to determine whether the corresponding sale information is present in the stored sale information, and authenticates the corresponding affiliated store as a result of the determination, the refund processor 191c in the free information usage certificate management server 100 requests the financial company server 500 through the settlement requester 180c to pay the corresponding affiliated store a refund of a returned amount of the free information usage certificates contained in the refund request information received by the refund request information receiver 190c, and updates the free information usage certificate management database 120c on the basis of the refund request information.

In this manner, the free information usage certificate service system according to the present invention can accomplish the above-presented objects.

### INDUSTRIAL APPLICABILITY

As apparent from the above description, according to a first embodiment of the present invention, there is provided a free information usage certificate service system which is capable of returning a portion of the price for online/offline product purchase or the fee for online/offline service use to a customer in the form of a free information usage certificate for free use of mobile contents as a reward for the product purchase or service use, so as to reduce the customer's burden of communication cost and thus enable the customer to benefit from a more tangible reward service. An affiliated store can provide free information usage certificates to customers instead of discount benefits or thank-you gifts, thereby obtaining the effect of performing public relations, sales promotion and customer enticement. A communication company can fixedly sell free information usage certificates in large quantities, so as to increase sales and secure stable earnings. A free information usage certificate service provider can purchase the free information usage certificates from the communication company in large quantities at low price and resell them at higher price, so as to obtain resale profits.

According to a second embodiment of the present invention, there is provided a free information usage certificate service system which is capable of returning a portion of the price for online/offline product purchase or the fee for online/offline service use to a customer in the form of a free information usage certificate for free use of mobile contents as a reward for the product purchase or service use, so as to reduce the customer's burden of communication cost and thus enable the customer to benefit from a more tangible reward service. An affiliated store can provide free information usage certificates to customers instead of discount benefits or thank-you gifts, thereby obtaining the effect of performing public relations, sales promotion and customer enticement. A free information usage certificate service provider can issue and sell free information usage certificates for free use of contents provided from a mobile contents provider associated therewith to the affiliated store at low price, so as to obtain sale profits. Customers can use the contents provided from the mobile contents provider over a communication network of a communication company using free information usage certificates, so that the communication company can continuously secure stable earnings.

According to a third embodiment of the present invention, there is provided a free information usage certificate service system which is capable of returning a portion of the price for online/offline product purchase or the fee for online/offline service use to a customer in the form of a free information usage certificate for free use of mobile contents as a reward for the product purchase or service use, so as to reduce the customer's burden of communication cost and thus enable the customer to benefit from a more tangible reward service. An affiliated store can provide free information usage certificates to customers instead of discount benefits or thank-you gifts, thereby obtaining the effect of performing public relations, sales promotion and customer enticement. A free information usage certificate service provider can issue and sell free information usage certificates for free use of contents provided from a mobile contents provider associated therewith to the affiliated store at low price, so as to obtain sale profits. The mobile contents provider can receive, from the free information usage certificate service provider, information usage fees settled using the free information usage certificates, so as to continuously secure stable earnings.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A free information usage certificate service system comprising a free information usage certificate management server including:
a free information usage certificate management database for storing information regarding sales of free information usage certificates from at least one mobile contents provider associated with at least one communication company or from the communication company itself, sold from the communication company to one or more affiliated stores;
a free information use request information receiver for receiving free information use request information containing a telephone number of a customer acquiring a specific one of the free information usage certificates and affiliated store identification information from a specific one of one or more affiliated store terminals held respectively by the affiliated stores;
an authentication processor for searching the sale information stored in the free information usage certificate management database for sale information corresponding to the affiliated store identification information to determine whether the corresponding sale information is present in the stored sale information, and performing an authentication process based on the determination result; and
a free information use request information transmitter for transmitting the free information use request information authenticated by the authentication processor to a communication company server managed by the communication company so that the communication company server can deduct the amount of money corresponding to the specific free information usage certificate acquired by the customer from an information usage fee to be charged to the customer's telephone number contained in the free information use request information.

2. The free information usage certificate service system as set forth in claim 1, wherein the free information usage certificate management server further includes:
a free information usage certificate purchase request information transmitter for transmitting free information usage certificate purchase request information to the communication company server; and
a free information usage certificate allocation information receiver for receiving free information usage certificate allocation information based on the free information usage certificate purchase request information from the communication company server.

3. The free information usage certificate service system as set forth in claim 2, wherein the free information usage certificate management server further includes:
a free information usage certificate purchase request information receiver for receiving free information usage certificate purchase request information from each of the affiliated store terminals; and
a free information usage certificate allocation information transmitter for transmitting free information usage certificate allocation information based on the free information usage certificate purchase request information received by the free information usage certificate purchase request information receiver to each of the affiliated store terminals.

4. The free information usage certificate service system as set forth in claim 3, wherein the free information usage certificate management server further includes a settlement requestor for transmitting settlement request information to at least one financial company server to request it to settle the affiliated stores' accounts for prices for purchases of the free information usage certificates, respectively, and then receiving results of the settlements from the financial company server.

5. The free information usage certificate service system as set forth in claim 4, wherein the free information usage certificate management server further includes:
a refund request information receiver for receiving refund request information containing a returned amount of the free information usage certificates and the affiliated store identification information from the specific affiliated store terminal; and
a refund processor for, if the authentication processor searches the sale information stored in the free information usage certificate management database for the sale information corresponding to the affiliated store identification information to determine whether the corresponding sale information is present in the stored sale information, and authenticates a specific one of the affiliated stores holding the specific affiliated store terminal as a result of the determination, requesting the financial company server through the settlement requestor to pay the specific affiliated store a refund of the returned free information usage certificate amount contained in the refund request information received by the refund request information receiver, and updating the free information usage certificate management database on the basis of the refund request information.

6. The free information usage certificate service system as set forth in any one of claims 1 to 5, further comprising the communication company server adapted for allocating the free information usage certificates to the free information usage certificate management server and, in response to the free information use request information from the free information usage certificate management server, deducting the amount of money corresponding to the specific free information usage certificate acquired by the customer from communication fees to be charged to the customer's telephone number contained in the free information use request information.

7. The free information usage certificate service system as set forth in claim 6, further comprising the one or more affiliated store terminals, each adapted for transmitting free information use request information containing a customer's telephone number and affiliated store identification information for authentication to the free information usage certificate management server.

8. The free information usage certificate service system as set forth in claim 7, wherein each of the affiliated store terminals is further adapted to transmit the free information usage certificate purchase request information to the free information usage certificate management server and receive the free information usage certificate allocation information based on the free information usage certificate purchase request information from the free information usage certificate management server.

9. The free information usage certificate service system as set forth in claim 7 or 8, further comprising the at least one financial company server adapted for processing the settlement associated with the free information usage certificate purchase request information from each of the affiliated store terminals.

10. The free information usage certificate service system as set forth in claim 9, further comprising at least one customer terminal for receiving guide information about a free information use service from the free information usage certificate management server and allowing a corresponding customer to use the free information use service free of charge using a free information usage certificate issued thereto.

11. The free information usage certificate service system as set forth in claim 10, wherein the customer terminal is a wireless communication terminal, the wireless communication terminal being any one of a mobile telephone or personal digital assistant (PDA).

12. The free information usage certificate service system as set forth in claim 11, wherein the free information usage certificate management server is adapted to transmit the guide information about the free information use service to the wireless communication terminal in the form of a short message service (SMS) message.

13. A free information usage certificate service system comprising a free information usage certificate management server including:
a free information usage certificate issuer for issuing free information usage certificates for free use of mobile contents provided from at least one mobile contents provider associated with the free information usage certificate management server;
a free information usage certificate management database for storing information regarding the issuance of the free information usage certificates from the free information usage certificate issuer and information regarding sales of the free information usage certificates to one or more affiliated stores;
a free information use request information receiver for receiving free information use request information containing a telephone number of a customer acquiring a specific one of the free information usage certificates and affiliated store identification information from a specific one of one or more affiliated store terminals held respectively by the affiliated stores;
an authentication processor for searching the sale information stored in the free information usage certificate management database for sale information corresponding to the affiliated store identification information to determine whether the corresponding sale information is present in the stored sale information, performing an authentication process based on the determination result, and storing information regarding the provision of the specific free information usage certificate to the customer in the free information usage certificate management database; and
a free information usage certificate manager for requesting and receiving information usage records of the customer acquiring the specific free information usage certificate, from a communication company server, calculating an information usage fee for use of the mobile contents provided from the associated mobile contents provider, to which the specific free information usage certificate acquired by the customer is applicable, from the received information usage records, deducting the calculated information usage fee from a free information usable fee contained in the free information usage certificate provision information stored in the free information usage certificate management database to update the free information usable fee, and requesting the communication company server to deduct the calculated information usage fee from an information usage fee to be charged to the customer's telephone number.

14. The free information usage certificate service system as set forth in claim 13, wherein the free information usage certificate management server further includes:
a free information usage certificate purchase request information receiver for receiving free information usage certificate purchase request information from each of the affiliated store terminals; and
a free information usage certificate allocation information transmitter for transmitting free information usage certificate allocation information based on the free information usage certificate purchase request information received by the free information usage certificate purchase request information receiver to each of the affiliated store terminals.

15. The free information usage certificate service system as set forth in claim 14, wherein the free information usage certificate management server further includes a settlement requestor for transmitting settlement request information to at least one financial company server to request it to settle the affiliated stores' accounts for prices for purchases of the free information usage certificates, respectively, and then receiving results of the settlements from the financial company server.

16. The free information usage certificate service system as set forth in claim 15, wherein the free information usage certificate management server further includes:
a refund request information receiver for receiving refund request information containing a returned amount of the free information usage certificates and the affiliated store identification information from the specific affiliated store terminal; and
a refund processor for, if the authentication processor searches the sale information stored in the free information usage certificate management database for the sale information corresponding to the affiliated store identification information to determine whether the corresponding sale information is present in the stored sale information, and authenticates a specific one of the affiliated stores holding the specific affiliated store terminal as a result of the determination, requesting the financial company server through the settlement requestor to pay the specific affiliated store a refund of the returned free information usage certificate amount contained in the refund request information received by the refund request information receiver, and updating the free information usage certificate management database on the basis of the refund request information.

17. The free information usage certificate service system as set forth in any one of claims 13 to 16, further comprising the communication company server adapted for receiving the request for the information usage records of the customer acquiring the specific free information usage certificate, from the free information usage certificate management server, transmitting the information usage records to the free information usage certificate management server in response to the received request, and deducting the information usage fee calculated by the free information usage certificate manager from the information usage fee to be charged to the customer's telephone number in response to the deduction request from the free information usage certificate management server.

18. The free information usage certificate service system as set forth in claim 17, further comprising the one or more affiliated store terminals, each adapted for transmitting free information use request information containing a customer's telephone number and affiliated store identification information for authentication to the free information usage certificate management server.

19. The free information usage certificate service system as set forth in claim 18, wherein each of the affiliated store terminals is further adapted to transmit the free information usage certificate purchase request information to the free information usage certificate management server and receive the free information usage certificate allocation information based on the free information usage certificate purchase request information from the free information usage certificate management server.

20. The free information usage certificate service system as set forth in claim 18 or 19, further comprising the at least one financial company server adapted for processing the settlement associated with the free information usage certificate purchase request information from each of the affiliated store terminals.

21. The free information usage certificate service system as set forth in claim 20, further comprising at least one customer terminal for receiving guide information about a free information use service from the free information usage certificate management server and allowing a corresponding customer to use the free information use service free of charge using a free information usage certificate issued thereto.

22. The free information usage certificate service system as set forth in claim 21, wherein the customer terminal is a wireless communication terminal, the wireless communication terminal being any one of a mobile telephone or PDA.

23. The free information usage certificate service system as set forth in claim 22, wherein the free information usage certificate management server is adapted to transmit the guide information about the free information use service to the wireless communication terminal in the form of an SMS message.

24. A free information usage certificate service system comprising a free information usage certificate management server including:
a free information usage certificate issuer for issuing free information usage certificates for free use of mobile contents provided from at least one mobile contents provider associated with the free information usage certificate management server;
a free information usage certificate management database for storing information regarding the issuance of the free information usage certificates from the free information usage certificate issuer and information regarding sales of the free information usage certificates to one or more affiliated stores;
a free information use request information receiver for receiving free information use request information containing a telephone number of a customer acquiring a specific one of the free information usage certificates and affiliated store identification information from a specific one of one or more affiliated store terminals held respectively by the affiliated stores;
an authentication processor for searching the sale information stored in the free information usage certificate management database for sale information corresponding to the affiliated store identification information to determine whether the corresponding sale information is present in the stored sale information, performing an authentication process based on the determination result, and storing information regarding the provision of the specific free information usage certificate to the customer in the free information usage certificate management database; and
a free information usage certificate manager for receiving free information usage certificate payment request information containing the customer's telephone number from a mobile contents provider server managed by the mobile contents provider, searching the free information usage certificate management database for free information usage certificate provision information corresponding to the customer's telephone number contained in the received free information usage certificate payment request information to determine whether the corresponding free information usage certificate provision information is present in the database, and, if the corresponding provision information is present in the database, deducting an information usage fee for contents used by the customer from a free information usable fee contained in the corresponding provision information to update the free information usable fee, and adding the information usage fee for the contents used by the customer to a total free information usage fee provided from the mobile contents provider, stored in the free information usage certificate management database, to update the total free information usage fee.

25. The free information usage certificate service system as set forth in claim 24, wherein the free information usage certificate management server further includes:
a free information usage certificate purchase request information receiver for receiving free information usage certificate purchase request information from each of the affiliated store terminals; and
a free information usage certificate allocation information transmitter for transmitting free information usage certificate allocation information based on the free information usage certificate purchase request information received by the free information usage certificate purchase request information receiver to each of the affiliated store terminals.

26. The free information usage certificate service system as set forth in claim 25, wherein the free information usage certificate management server further includes a settlement requestor for transmitting settlement request information to at least one financial company server to request it to settle the affiliated stores' accounts for prices for purchases of the free information usage certificates, respectively, and then receiving results of the settlements from the financial company server.

27. The free information usage certificate service system as set forth in claim 26, wherein the free information usage certificate management server further includes:
a refund request information receiver for receiving refund request information containing a returned amount of the free information usage certificates and the affiliated store identification information from the specific affiliated store terminal; and
a refund processor for, if the authentication processor searches the sale information stored in the free information usage certificate management database for the sale information corresponding to the affiliated store identification information to determine whether the corresponding sale information is present in the stored sale information, and authenticates a specific one of the affiliated stores holding the specific affiliated store terminal as a result of the determination, requesting the financial company server through the settlement requester to pay the specific affiliated store a refund of the returned free information usage certificate amount contained in the refund request information received by the refund request information receiver, and updating the free information usage certificate management database on the basis of the refund request information.

28. The free information usage certificate service system as set forth in any one of claims 24 to 27, further comprising the mobile contents provider server adapted for transmitting records of free use of its contents by customers to the free information usage certificate management server and requesting the free information usage certificate management server to pay a specified amount of money corresponding to the provided total free information usage fee.

29. The free information usage certificate service system as set forth in claim 28, further comprising the one or more affiliated store terminals, each adapted for transmitting free information use request information containing a customer's telephone number and affiliated store identification information for authentication to the free information usage certificate management server.

30. The free information usage certificate service system as set forth in claim 29, wherein each of the affiliated store terminals is further adapted to transmit the free information usage certificate purchase request information to the free information usage certificate management server and receive the free information usage certificate allocation information based on the free information usage certificate purchase request information from the free information usage certificate management server.

31. The free information usage certificate service system as set forth in claim 29 or 30, further comprising the at least one financial company server adapted for processing the settlement associated with the free information usage certificate purchase request information from each of the affiliated store terminals.

32. The free information usage certificate service system as set forth in claim 31, further comprising at least one customer terminal for receiving guide information about a free information use service from the free information usage certificate management server and allowing a corresponding customer to use the free information use service free of charge using a free information usage certificate issued thereto.

33. The free information usage certificate service system as set forth in claim 32, wherein the customer terminal is a wireless communication terminal, the wireless communication terminal being any one of a mobile telephone or PDA.

34. The free information usage certificate service system as set forth in claim 33, wherein the free information usage certificate management server is adapted to transmit the guide information about the free information use service to the wireless communication terminal in the form of an SMS message.
